(19) United States
(12) Patent Application Publication
(10) Pub. No.: US 2023/0234105 A1
(43) Pub. Date: Jul. 27, 2023

(54) SELF-CLEANING BARBECUE

(71) Applicant: Harry Zeritis, Scarborough (CA)

(72) Inventor: Harry Zeritis, Scarborough (CA)

(21) Appl. No.: 18/128,277

(22) Filed: Mar. 30, 2023

Related U.S. Application Data
(63) Continuation-in-part of application No. 16/591,900, filed on Oct. 3, 2019.

(51) Int. Cl. B08B 3/02; A47J 37/07

(52) U.S. Cl. CPC B08B 3/028; A47J 37/0786

(57) ABSTRACT

A self-cleaning barbecue comprising of a built-in power washer system.

### REFERENCE TO PENDING APPLICATIONS

This application claims the benefit of pending application Ser. No. 16/591,900 filed on Oct. 3, 2019, entitled Self-Cleaning Barbecue.

### BACKGROUND OF THE INVENTION

### 1. Field of the Invention

The present invention in generally directed to a barbecue grill, and more particularly, relates to a self-cleaning barbeque grill.

### 2. Description of the Related Art

Presently, many examples of barbecue maintenance procedures exist but are either time consuming, physically exhausting, potentially unhealthy and unsafe or some combination of the aforementioned. Rust or burned food collected on the grates of the barbecue possess long term health issues as these contaminates can flake off of the grate and fuse into the food that is being cooked. A common solution for this involves the use of wire grill brushes, however, under some circumstances, the brush wires can break off and become fused with the food. Ingestion of the brush wires can lead to a plethora of health issues such as puncturing the stomach, esophagus, intestines or liver. Furthermore, rigorous manual cleaning the grates can be an exhausting and time consuming process. There exists a need for a convenient cleaning system that is built into the barbecue.

Current built-in, self-cleaning barbecue models involve elevating the temperature of the grates through supplemental gas input and electrical conduction. The self-cleaning models by way of supplemental gas input attempt to burn off any residual food and grease but applying additional nozzles directed at the grate in order for the grate to reach high enough temperatures to enable vaporization of any residual food and grease present on the grates. This method requires additional gas input which can become costly with frequent maintenance and present potentially harmful vapors to the consumer if ingested. Also, this model requires the barbecue to be especially thermally insulated in order to reduce input gas required and maintain the high temperatures required for vaporization. The electrical conduction models use electricity to heat up the grates to high enough temperatures to enable vaporization of any residual food and grease present on the grates. This method requires additional electric input which can become costly with frequent maintenance and present potentially harmful vapors to the consumer if ingested.

There exists a need for a self-cleaning barbecue that preforms safe, timely and effortless maintenance all the while contributing to a healthier grilling experience and preservation of the grates and the barbecue's prestige.

### SUMMARY OF THE INVENTION

The present aspect encompasses a self-cleaning barbecue comprising of a built-in power washer system. In further aspect, a series of power-wash nozzles are affixed to the hood of the self-cleaning barbecue. In other aspect, the power-wash nozzles are in a static position. In other aspect, the power-wash nozzles are individually modifiable in their orientations. In other aspect, the power-wash nozzles are rotating in place. In other aspect, the power-wash nozzles are affixed to a track that is attached to the hood of the self-cleaning barbecue. In other aspect, the track is mobile in a horizontal direction. In other aspect, the track is mobile in a vertical direction. In other aspect, the track is mobile in horizontal and vertical directions. In other aspect, the power-wash nozzles produce a uniform volumetric flow rate. In other aspect, the power-wash nozzles produce a pulsating volumetric flow rate. In other aspect, the power-wash nozzles volumetric flow rates are individually modifiable. In other aspect, the power-wash system is affixed to side of the self-cleaning barbecue. In other aspect, the power-wash system is affixed underneath the grates of the self-cleaning barbecue. In other aspect, the power-wash system is removable. In other aspect, the power-wash system is independent from the self-cleaning barbecue. In other aspect, the power-wash system is adaptable for alternate input hose sources. In other aspect, the power-wash system contains a supplementary compartment for storing a specialized barbecue cleaning product to be dispensed as required. In other aspect, a container is located underneath the grates of the self-cleaning barbecue in order to collect used water. In other aspect, the container is removable. In other embodiments, the container acts to drain the collected water.

The features of the invention which are believed to be novel are particularly pointed out in the specification. The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

To easily identify the discussion of any particular element or act, the most significant digit or digits in a reference number refer to the figure number in which that element is first introduced.

FIG. 1 illustrates a uniform volumetric flow rate self-cleaning barbecue 100 in accordance with one embodiment.

FIG. 2 illustrates a customizable volumetric flow rate self-cleaning barbecue 200 in accordance with one embodiment.

The various embodiments of the present invention will hereinafter be described in conjunction with the appended drawings, wherein like designations denote like elements.

### DETAILED DESCRIPTION

The details of one or more embodiments of the subject matter of this specification are set forth in the accompanying drawings and the description below. Other features, aspects, and advantages of the subject matter will become apparent from the description, the drawings, and the claims. Like reference numbers and designations in the various drawings indicate like elements.

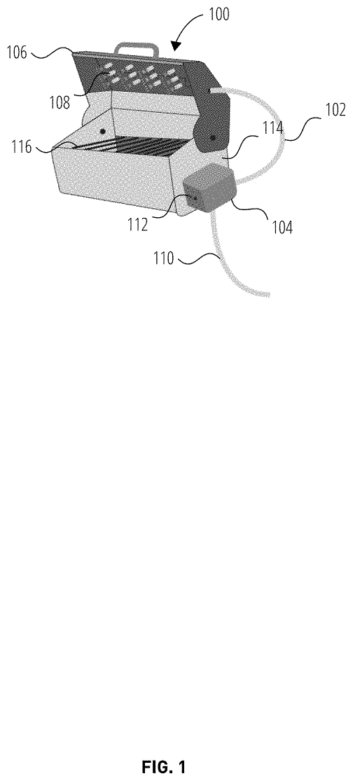

FIG. 1 provides an overview of a uniform volumetric flow rate self-cleaning barbecue 100 as used in one embodiment. This example displays a collection of power-wash nozzles 108 that are housed underneath the self-cleaning barbecue hood 106. In other embodiments, the power-wash nozzles 108 may be affixed to a track that is mobile in a horizontal direction, vertical direction or both horizontal and vertical directions. An input hose 110 is connected to a power-wash system 104 as known in the art, that is affixed to the side of the self-cleaning barbecue.

For purposes of this application, the term power-wash system refers to a power-washer, otherwise known as a pressure washer. This system provides pressurized water flow at approximately 1000-4000 pounds per square inch (psi). The main parts of the system include a water inlet, an electric motor or gas engine, a water pump, and a reinforced high-pressure hose. Typically, the reinforced hose includes wire mesh and has two or more layers of high-density plastic. Further, a cleaning attachment is attached to the high-pressure hose. In these embodiments, the cleaning attachment are the power-wash nozzles 108.

The power-wash system 104 may also be located underneath the grates of the self-cleaning barbecue 116, removable or independent from the self-cleaning barbecue but within close proximity to the self-cleaning barbecue. A connection hose 102 joins the power-wash system 104 and the self-cleaning barbecue hood 106, delivering the pressurized water to the power-wash nozzles 108. In other embodiments, the power-wash system 104 is adaptable for alternate input hose sources. Embodiments of various positions of the power-wash nozzles 108 include but are not limited to static nozzles, rotating nozzles, individually modifiable in their orientations, or any combination of the aforementioned. With respect to the rotating nozzles, these nozzles rotate due to the force of the water flowing therethrough.

The power-wash system 104 includes one or more power-wash system controls 112 to control the volumetric flow rate of water to all or part of the power-wash nozzles 108, nozzle track mobility, a timed operation mode and a cleaning solution dispensing mode. The power-wash system 104 may also include security mechanisms such that it cannot be enabled while the self-cleaning barbecue is turned on.

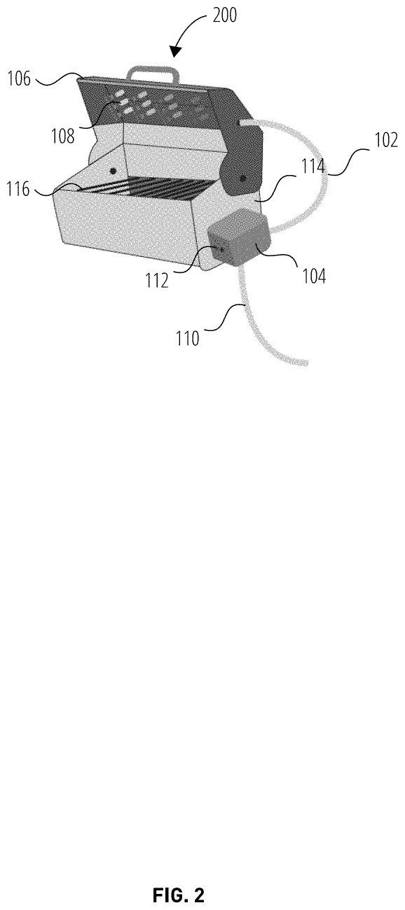

FIG. 2 provides an overview of customizable volumetric flow rate self-cleaning barbecue 200. This example displays a collection of power-wash nozzles 108 that are housed underneath the self-cleaning barbecue hood 106. The power-wash nozzles 108 can be manually or automatically adjusted to alter the volumetric flow rate of the output water across each individual nozzle. An input hose 110 is connected to a power-wash system 104 that is affixed to the side of the self-cleaning barbecue 114. A connection hose 102 joined to the power-wash system 104 and the self-cleaning barbecue hood 106, delivering the pressurized water to the power-wash nozzles 108. In one embodiment, the power-wash system controls 112 allow for switching between a constant volumetric flow rate mode and a pulsating flow rate mode. Furthermore, additional embodiments include but are not limited to a supplementary compartment within the power-wash system 104 which stores specialized barbecue cleaning products to be dispensed as required and a container located underneath grates of the self-cleaning barbecue 116 for the purpose of collecting the water that is either removable, may act as a drain or both.

The exact specifications and materials used in the manufacture of the apparatus of the present invention may vary upon manufacturing.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment(s) were chosen and described in order to best explain the principles of the present invention and its practical application, to thereby enable others skilled in the art to best utilize the present invention and various embodiments with various modifications as are suited to the particular use contemplated.

What is claimed is:

1. A self-cleaning barbecue comprising:
a grill body;
a grill hood rotationally connected to the grill body; and
a power washer system affixed to an exterior wall of the grill body,
the power washer system connected to an input hose and configured to receive input water through the input hose,
the power washer system connected to a connection hose and configured to delivery pressurized water through the connection hose, the pressurized water having a pressure of between 1000 psi and 4000 psi,
a plurality of power-wash nozzles being affixed to an interior surface of the grill hood, the plurality of power-wash nozzles being in communication with the connection hose and configured to discharge the pressurized water into the interior of the grill body.

2. The barbecue of claim 1 herein the power-wash nozzles are in a static position.

3. The barbecue of claim 2 wherein the power-wash nozzles are individually modifiable in their orientations.

4. The barbecue of claim 1 wherein the power-wash nozzles are rotating in place.

5. The barbecue of claim 1 wherein the power-wash system is removable from the grill body.

6. The barbecue of claim 1 wherein the power-wash system is independent from the self-cleaning barbecue.

7. The barbecue of claim 1 wherein the power-wash system is adaptable for alternate input hose sources.

8. The barbecue of claim 1 wherein the power-wash system contains a supplementary compartment for storing a specialized barbecue cleaning product to be dispensed as required.

9. The barbecue of claim 1 wherein the flow of the pressurized water through the connection hose has a uniform volumetric flow rate.

10. The barbecue of claim 1 wherein the flow of the pressurized water through the connection hose has a pulsating volumetric flow rate.

11. The barbeque of claim 1, further comprising:
a power wash system control in communication with the power washer system and configured to switch the flow of the pressurized water through the connection hose between a uniform volumetric flow rate and a pulsating volumetric flow rate.

12. The barbeque of claim 1 wherein the pressurized water having a pressure of between 1500 psi and 3000 psi.
